(19) United States
(12) Patent Application Publication
(10) Pub. No.: US 2007/0275817 A1
(43) Pub. Date: Nov. 29, 2007

(54) Asymmetric Roller Crown

(76) Inventor: Jonathan Paul Newall, Chorley (GB)

Correspondence Address: Blakely, Sokoloff, Taylor & Zafman, 12400 Wilshire Boulevard, 7th Floor, Los Angeles, CA, 90025, US

(21) Appl. No.: 10/579,453

(22) PCT Filed: Nov. 1, 2004
(86) PCT No.: PCT/GB04/04614

§ 371 Date: Feb. 15, 2007

(30) Foreign Application Priority Data
Nov. 11, 2003 (GB) 0326205.2

(51) Int. Cl. F16H 15/38

(52) U.S. Cl. 476/10

(57) ABSTRACT

The present invention is concerned with the formation of rollers in a rollingtraction toroidal-race type of continuously variable ratio transmission device (“variator”). Specifically, it concerns variators of the “full-toridal” type in which the variator rollers (48) are permitted to adopt a position in which their centres are close to—or even coincident with—the center line of a toroidal cavity defined by races (30, 32, 42). It has been recognised that the roller centres do not, in such a variator, lie precisely upon the centre line of the variator cavities. Consequently in order to optimise roller performance there is provided, in accordance with the present invention, a roller (70) having an outer perimeter which, viewed in a sectional plane containing the roller axis, has a convex profile which is not symmetrical about any plane perpendicular to the roller axis.

The present invention is concerned with the formation of rollers in a rolling-traction toroidal-race type of continuously variable ratio transmission device (“variator”).

Such variators are well known in the field of motor vehicle transmissions and have potential applications in certain other fields. They comprise at least two races which are co-axially mounted and respective facing surfaces of which are shaped to form together a cavity in the shape of a torus. Rollers disposed in the cavity each run upon the shaped surfaces of the races and serve to transmit drive from one race to the other. The angles between the roller's axes and the common axis of the races are variable (that is, the rollers are able to change their inclination) in accordance with changes in the variator's transmission ratio. In this way the variator provides a continuously variable drive ratio.

The rollers and races do not actually come into contact with each other. Instead a film of fluid (referred to as “traction fluid”) is maintained between them, typically by spraying it into the region of the region of engagement between each roller and race. Drive is transmitted between roller and race by virtue of shear in the fluid film in a manner well known in this art.

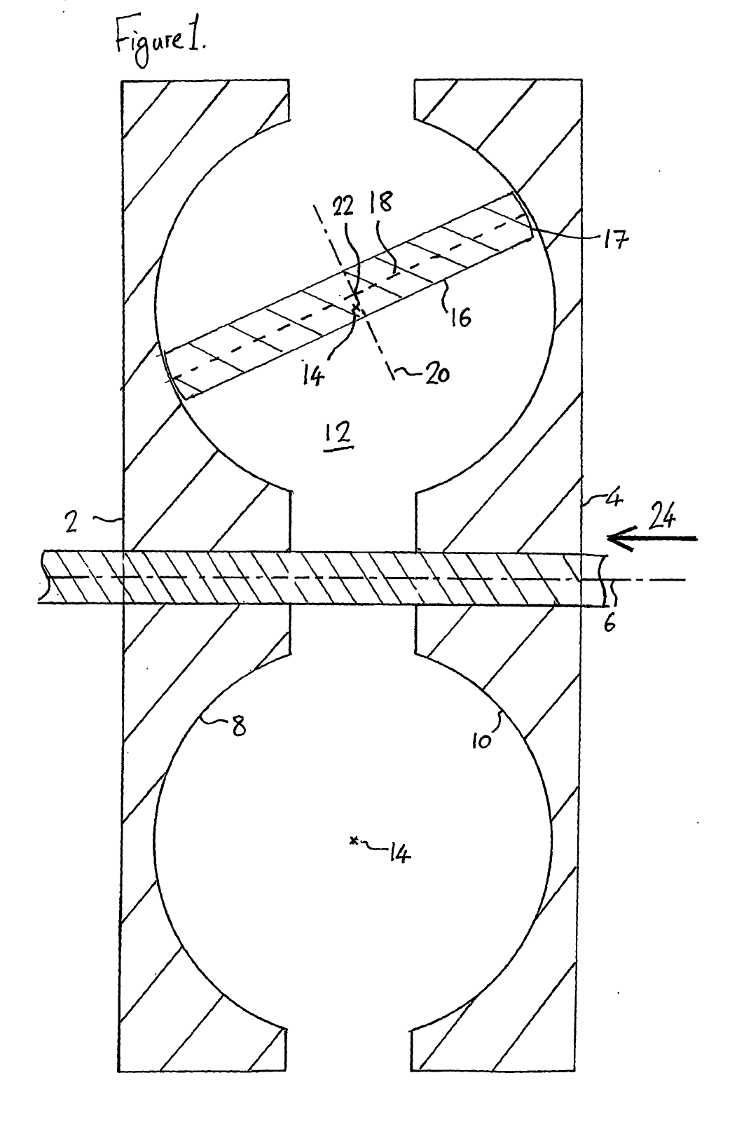

In order to illustrate and explain the design of existing variator rollers, reference is directed to FIG. 1 which is a highly simplified section in a plane containing the variator axis through selected components of a variator of “full toroidal” type. The two variator races are seen at 2,4 and the variator axis about which they rotate is indicated at 6. The shaped faces 8,10 of the respective races together define a cavity 12 which is generally toroidal, its section in any plane containing the variator axis comprising two circles to either side of the axis (although because the races do not meet the circles defined by them are incomplete). The centre point of the circle defined by the races is indicated by crosses 14 in both the upper and lower halves of the drawing. The locus of such points is a circle about the variator axis which will be referred to as the centre line of the cavity.

The drawing shows only one roller 16 although in a practical variator a plurality of rollers is typically provided. Also to make the drawing as simple as possible the roller is positioned such that its axis lies in the plane of the paper. The roller's outer perimeter has a crowned profile at 17. This profile is, when viewed as in FIG. 1 in a sectional plane containing the roller axis, an arc of a circle. The curvature of the crown has a slightly smaller radius than the curvature of the adjacent faces of the variator races. This difference has been exaggerated in FIG. 1 for clarity. A dotted line 18 in FIG. 1 represents what will be referred to as the centre plane of the roller, which is the plane perpendicular to the roller axis 20 and half way along the crown of the roller. In the prior art roller design, the crown is symmetrical about the centre plane. The centre of curvature of the crown lies in the centre plane of the roller. It will be convenient in the following discussion to refer to the roller centre, which is the intersection of the roller axis 20 with the centre plane 18 and is indicated at 22.

To generate pressure in the regions of engagement between the roller and the races, an “end load” force (indicated by an arrow 24) is applied to one of the races, urging it toward the other. This force is resisted by the roller interposed between the two races and tends to cause the roller to assume a position in which its centre 22 lies upon the centre line 14 of the toroidal cavity, since to move away from this position the roller must force the two races away from each other against the end load. It has hitherto been assumed that in operation the roller consequently adopts such a position.

For present purposes it is important to distinguish between “full” and “part” toroidal variators. An example of a part toroidal variator, chosen from a large body of patent literature relating to such variators, is U.S. Pat. No. 5,368,529—Machida. Here the rollers are positioned radially inboard of the centre line of the toroidal cavity.

In the region where they engage with each roller, the two races have surfaces which diverge along the radially outward direction. Hence the effect of pressure from the races upon the roller is to urge the roller radially outwards. To keep the roller in its radial position this outward force must be resisted by the rollers mounting—Machida achieves this through a thrust bearing whose axis lies along a radial direction. Because the roller in a part toroidal variator engages with divergent surfaces of the variator races, its profile is necessarily highly asymmetric.

The present invention is not relevant to part toroidal variators.

The term “full toroidal” as used herein denotes a different type of variator in which, as in the FIG. 1 example, the roller is permitted to adopt a position in which its centre is close to—or coincident with—the centre line of the toroidal cavity. In such a variator the radial position of the roller can be determined by the action of the races on the roller, rather than being controlled by the roller's mounting.

The present invention results from a recognition that when a full toroidal variator is operating, the roller centre does not in fact precisely coincide with the centre line of the toroidal cavity. Instead the roller centre 22 is slightly outwardly displaced from the cavity centre 14, as seen in the drawing. This displacement is again somewhat exaggerated in the drawing so that it can be clearly seen.

For optimal roller performance it is necessary to take account of this observation in designing the roller crown.

In accordance with the present invention there is a roller for a continuously variable ratio device (“variator”) of the full toroidal type in which a pair of races mounted for rotation about a common axis together define a substantially toroidal cavity and the roller is disposed in the cavity and runs upon the races to transfer drive between them, the roller having an outer perimeter which, viewed in a sectional plane containing the roller axis, has a convex profile and which is not symmetrical about any plane perpendicular to the roller axis.

This asymmetry of the roller perimeter serves to allow for the displacement of the roller from the centre of the toroidal cavity.

Specific embodiments of the present invention will now be described, by way of example only, with reference to the accompanying drawings in which:

FIG. 1 is a highly simplified section, in a plane containing the variator axis, through certain major components of a known full toroidal rolling traction type variator;

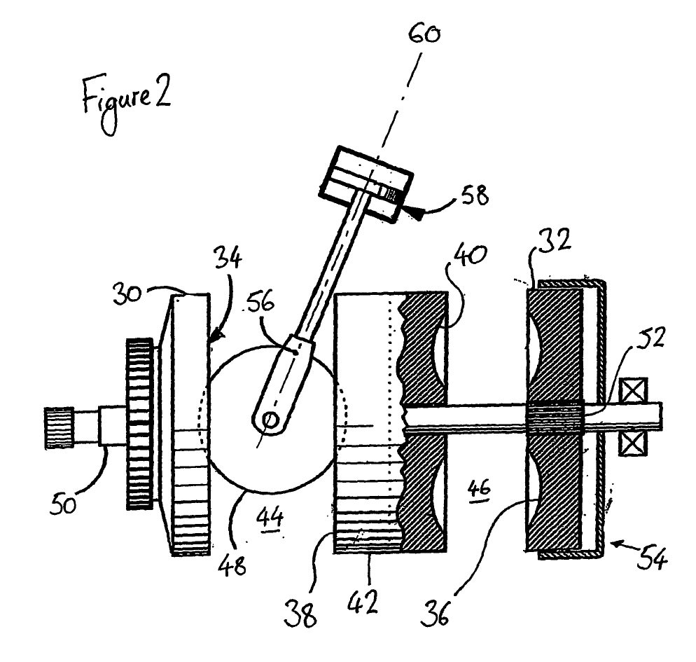

FIG. 2 is a further simplified illustration of major components of a known full toroidal rolling traction type variator, viewed along a radial direction and partly in section; and

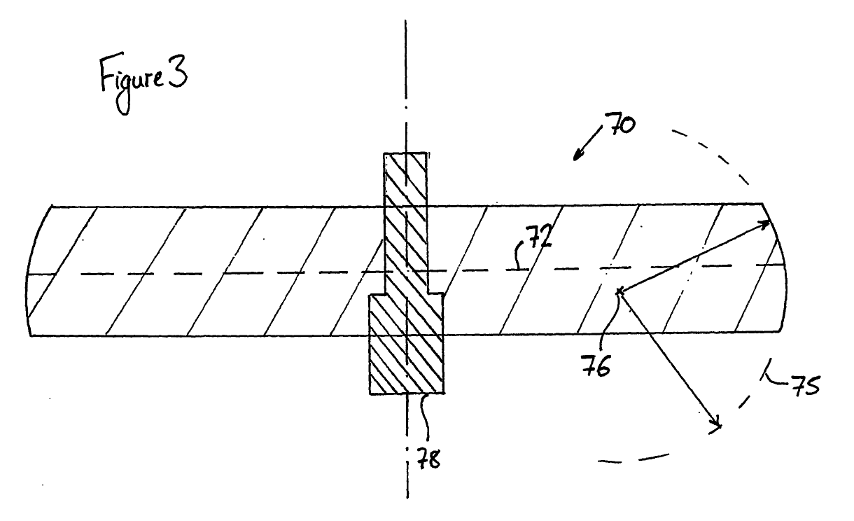

FIG. 3 is a section, in a plane containing the roller axis, through a roller constructed in accordance with the present invention.

It is not intended to provide a detailed description of the construction and operation of a toroidal race type variator herein. Such details are known in the art and are to be found in various published patents and applications in the name of Torotrak (Development) Ltd including for example EP444086. However to assist the reader a brief description of the principle of operation of one particular toroidal race variator will now be provided with reference to FIG. 2. This variator has a pair of outer discoidal races 30, 32 with respective shaped faces 34, 36 both facing toward respective shaped faces 38, 40 of an inner discoidal race 42. Hence two toroidal cavities 44, 46 are defined and each cavity in this example contains three rollers which move in unison with each other, although for the sake of clarity only one of the rollers 48 is illustrated. The common axis of the races is defined by a shaft 50. The inner race 42 is journalled to be rotatable independently of the shaft while the outer races are coupled to the shaft such as to rotate along with it. In the case of right hand outer race 32 this coupling is achieved by means of splines 52 so that some axial displacement of this race is possible under the influence of a hydraulic end load actuator 54. Because the inner race 42 has some axial “float” and the left hand outer race 30 is axially fixed relative to the shaft, the end load force from the actuator 54 serves to urge all three races toward each other, creating the pressures needed for engagement of the rollers with the races. Drive can be input to the variator through the shaft 50 and taken off from the inner race 42, or vice versa.

Each roller is journalled in a carriage 56 acted upon by a hydraulic roller actuator 58 which biases the roller along a direction generally circumferential with respect to the races and the roller is able to move along this direction. As well as being capable of this translational motion, the roller is also able to “precess”. That is, the inclination of the roller can vary about an axis 60 determined by the arrangement of the roller and its actuator 58. Because this precession of the rollers (which is executed by all of the rollers in unison) changes the relative diameters of the paths traced upon the races by the rollers, it is accompanied by a change in variator ratio. The axis 60 is inclined to the axis of the variator shaft 50, as shown, and consequently translational movement of the roller back and forth along the circumferential direction is accompanied by corresponding precessional movement and ratio change. Hence by controlling the force from roller actuator 58, the variator behaviour is controlled.

Note that the roller's mountings allow it also some freedom to move toward/away from the shaft 50. As already explained, the roller's radial position is determined not by its mountings but by the influence of the races. It has also been explained above that the roller centre is in operation not precisely coincident with the centre line of the toroidal cavity. This is contrary to expectation but is confirmed by observation of the pattern of wear on the roller. Engagement between the roller and race produces a wear band upon the roller crown and on the symmetrical type of roller described with reference to the prior art this band is slightly displaced from the centre of the crown, this displacement being interpreted as an indication of the displacement of the roller from the centre of the cavity.

The explanation for this displacement is believed to be as follows (although this explanation is not intended in any way to limit the scope of the invention as claimed). There is relative motion between the surfaces of the roller and race in the region where one engages with the other and this can be thought of as comprising two components:
i. a linear relative motion along a direction tangential to the circle traced upon the race by the roller. This relative linear motion is inevitable in order to create the required shear in the film and is referred to herein as “slip”; and
ii. relative rotational motion of the two surfaces. This arises because the surface of the race is of course following a path which is a circle centred upon the race axis. It is referred to herein as “spin”.

Furthermore the region of engagement between the roller and the race is not a point contact but extends across a significant part of the roller crown due to the depth of the traction fluid film through which the engagement takes place. The effect of the combination of slip and spin over a finite region of engagement is that the force exerted upon the roller by the fluid comprises not only a circumferential component (as necessary for the roller to transfer drive to/from the race) but also a lateral component. It is this lateral component which urges the roller away from the variator shaft and causes the aforementioned displacement.

Since the roller displacement was first recognised, a paper analysing the forces in an engagement involving both shear and spin has been found. “Observations of Viscoelastic Behaviour of an Elastohydrodynamic Lubricant Film”, Johnson and Roberts, published in Proceedings of the Royal Society of London, Series A, Mathematical and Physical Sciences, Volume 337, Issue 1609 (Mar. 19, 1974) pages 217-242, provides a mathematical analysis of the behaviour of fluid in this type of engagement, although it concerns itself with lubricant films in general (e.g. between gear teeth) and its relevance to the present phenomenon is believed not to have been previously recognised.

The displacement of the region of engagement from the centre of the roller crown could have a deleterious effect upon roller performance. The compressive forces upon the rollers are very large in motor vehicle variators. The working lifetime of the roller is one of the major factors in longevity of the variator as a whole and needs to be maximised. An asymmetric stress distribution is undesirable in this context. Also there are incentives to minimise the width of the roller and its crown but this must be done without causing the region of engagement to extend beyond the crown itself, since it is believed the tribology of the engagement would then be impaired.

For both reasons it is desirable to centre the region of engagement on the roller crown. On the face of it this might appear highly problematic because the forces determining the displacement of the roller centre are in practice subject to constant variation. The end load, tending to centre the roller in the cavity, is in current variators deliberately varied by changing the pressure in the end load actuator 54 according to operating conditions. The lateral force tending to displace the roller centre also varies with end load and other factors. It might be assumed therefore that the roller displacement would vary significantly in operation. However it has been established that, to an acceptable approximation, the above variations cancel each other out and the roller displacement can be taken to be constant.

Consequently the displacement of the roller can be compensated by appropriate design of the roller crown and a suitable roller 70 is illustrated in FIG. 3. The centre plane of the roller is indicated by a dotted line 72 and is again defined as the plane perpendicular to the roller axis and containing the mid point of the crown. The crown is, in this section through the roller, seen to be shaped as an arc of a circle 75 whose centre 76 is offset from the roller's centre plane. It is this offset which compensates for the roller displacement. The resulting crown is not symmetrical about the centre plane (nor about any other plane perpendicular to the roller axis.) This asymmetry causes the region of engagement between the roller and the race to be positioned at, or at least nearer to, the centre of the crown than in the prior art.

The illustrated crown design is not considered to be the only possible design to achieve the desired result. For example the shape of the crown need not be an arc of a circle as such.

Because of its asymmetry, the roller must be correctly orientated during assembly, a requirement which did not arise with the symmetrical prior art roller. It is desirable to guard against incorrect assembly and this may for example be achieved by forming bearings on the two sides of the roller with different interior diameters, a shaft 78 carrying the roller being complementarily formed so that it cannot be wrongly inserted.

1. A roller for a continuously variable ratio device (“variator”) of the full toroidal type in which a pair of races mounted for rotation about a common axis together define a substantially toroidal cavity and the roller is disposed in the cavity and runs upon the races to transfer drive between them, the roller having an outer perimeter which, viewed in a sectional plane containing the roller axis, has a convex profile and which is not symmetrical about any plane perpendicular to the roller axis.

2. A roller as claimed in claim 1 wherein the largest diameter of the roller crown is offset from the mid point of the crown.

3. A roller as claimed in claim 1 wherein the roller crown, viewed in the aforementioned sectional plane, is an arc of a notional circle whose centre is offset from the centre plane, defined as the plane perpendicular to the roller axis containing the mid point of the crown.

4. A variator comprising a roller as claimed in claim 1, the variator further comprising a pair of races mounted for rotation about a common axis and together defining a substantially toroidal cavity, the roller being disposed in the cavity and running upon the races to transfer drive between them.

5. A variator as claimed in claim 4 wherein the largest diameter of the roller crown is displaced from the mid point of the crown in a direction toward the variator axis.

6. A variator as claimed in claim 4 wherein the regions of engagement between the roller and the races are centred upon the crown of the roller despite the roller centre being offset in operation from the centre line of the toroidal cavity.

7. A variator as claimed in claim 1 wherein the roller is provided with mountings which permit it to float along a direction which is radial with respect to the common axis of the races, the roller's radial position being determined by the action of the races upon it.

8-9. (canceled)
